(19) United States
(12) Patent Application Publication
(10) Pub. No.: US 2014/0284390 A1
(43) Pub. Date: Sep. 25, 2014

(54) NETWORKED MONITOR FOR HEATING VENTILATION AND AIR CONDITIONING SYSTEMS

(71) Applicant: DEXEN INDUSTRIES, INC., Santa Fe Springs, CA (US)

(72) Inventors: Patrick Teng, Santa Fe Springs, CA (US); George Takahiro Suzuki, Santa Fe Springs, CA (US); Yu-Shan Teng, Santa Fe Springs, CA (US); Eric Cho, Santa Fe Springs, CA (US)

(73) Assignee: Dexen Industries, Inc., Santa Fe Springs, CA (US)

(21) Appl. No.: 13/849,470

(22) Filed: Mar. 23, 2013

(51) Int. Cl. G05D 23/19

(52) U.S. Cl. CPC G05D 23/19
USPC 236/51

(57) ABSTRACT

A system for providing monitoring of HVAC systems includes a database comprising a plurality of computing device records, and a plurality of technician records. The system further includes a computing device connected to the HVAC system, the computing device comprising a network interface device, an optical sensor located adjacent to one or more light emitting devices of the HVAC system, and a processor for reading the sensor data from the optical sensor and transmitting the sensor data to a server. The system further includes a server for receiving the sensor data, finding a technician within the vicinity that can service the HVAC system and sending a message to the technician including the sensor data and the contact information for the owner of the HVAC system, so that the technician may service the HVAC system.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the field of heating, ventilation and air conditioning (HVAC) systems and, more specifically, to servicing HVAC systems using telecommunications networks.

### BACKGROUND

Heating, ventilation and air conditioning (HVAC) systems are ubiquitous in modern society and comprise a worldwide industry. One of the important sectors of the HVAC industry involves the servicing of HVAC systems. A variety of problems, however, are associated with the process of servicing HVAC systems. Typically, consumers become aware of problems with their HVAC systems only when the system fails to provide adequate heating, ventilation and/or air conditioning. This motivates the consumer to start a search for a servicer of the HVAC system, which often comprises looking for a service technician on the internet, in local telephone books or via word of mouth. Service technicians, however, have different specialties and therefore not every HVAC technician possesses the skills to service every HVAC system. Thus, a consumer must find an HVAC technician that has the skills to service the exact type of the consumer's HVAC system. This could lengthen a consumer's search for an HVAC technician, during which time the consumer is without a functioning HVAC system, which can be uncomfortable and even dangerous during seasons with extreme temperatures.

The process of finding an appropriate HVAC technician to service an HVAC system can also be hampered by schedules and distances. A consumer may be successful in finding an HVAC technician with the appropriate skills but the HVAC technician may not have time in his schedule to service the consumer's system or the HVAC technician may simply be located too far away from the consumer to make it feasible to service the HVAC system.

Another problem associated with the servicing of HVAC systems involves the need for replacement parts. Usually, an HVAC technician must personally visit an HVAC system to determine which parts, if any, require replacement. After this determination is made, the HVAC technician must leave the premises to acquire the replacement part he identified and return to service the HVAC system. Thus, this process requires a minimum of two in-person visits to the malfunctioning HVAC system. This process prolongs the service experience and lengthens the time the consumer is without a functioning HVAC system.

Therefore, a need exists for improvements over the prior art, and more particularly for methods and systems that reduce the complexity, cost and time associated with detecting problems with an HVAC system, finding an appropriate HVAC technician to service the system and servicing the HVAC system.

### SUMMARY

A method and system that facilitates monitoring of an HVAC system communicatively coupled with a communications network is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a distributed system for providing monitoring of HVAC systems includes 1) a database connected to a communications network, the database comprising: a) a plurality of device records, wherein each device record includes a device unique identifier, device owner contact information, a device message format, device sensor parameter data and a first device type, and b) a plurality of technician records, wherein each technician record includes technician contact information and a list of device types representing devices serviced by the technician; 2) a computing device connected to the HVAC system, the computing device comprising: a network interface device for connecting the computing device to the communications network; an optical sensor located adjacent to one or more light emitting devices of the HVAC system, the optical sensor for sensing light emanating from the light emitting devices and generating corresponding sensor data; a processor for reading the sensor data from the optical sensor and transmitting a message over the communications network via the network interface device, wherein the message is formatted according to the message format of the computing device and wherein the message includes the sensor data and a device unique identifier.

The distributed system further includes 3) a server comprising: a network interface device for connecting the server to the communications network; and a processor configured for: a) receiving the message from the computing device via the network interface device, b) reading the device unique identifier in the message, c) searching for and identifying a device record in the database that matches the device unique identifier, d) reading from the device record the device owner contact information, device message format, device sensor parameter data and the first device type, e) reading the sensor data from the message according to the device message format and the device sensor parameter data, f) searching for and identifying a technician record in the database having an address in the technician contact information within a predefined area of an address of the device contact information, and having a device type that matches the first device type, and g) sending, via the network interface device, a message to the technician using the technician contact information, wherein the message includes the sensor data, the first device type and the device owner contact information.

### BRIEF DESCRIPTION OF THE DRAWINGS

The accompanying drawings, which are incorporated in and constitute a part of this disclosure, illustrate various example embodiments. In the drawings:

FIG. 1 is a diagram of an operating environment that supports a process for monitoring heating, ventilation and air conditioning (HVAC) systems and facilitating service calls over a communications network, according to an example embodiment;

FIG. 2 is a block diagram showing the main components of computing device for monitoring HVAC systems using the communications network, according to an example embodiment;

FIG. 3 is a block diagram showing the overall functions performed by the main components of the system for monitoring HVAC systems and facilitating service calls over the communications network, according to an example embodiment;

FIG. 4A is a diagram showing the data flow of the registration process for over the communications network, according to an example embodiment;

FIG. 4B is a diagram showing the data flow of the monitoring process over the communications network, according to an example embodiment;

FIG. 5 is a flow chart showing the control flow of the process for monitoring HVAC systems and facilitating service calls over the communications network, according to an example embodiment;

FIG. 6 is a block diagram of a system including a computing device, according to an example embodiment.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

The methods and systems of the invention reduce the complexity, cost and time associated with detecting problems with an HVAC system, finding an appropriate HVAC technician to service the system and servicing the HVAC system. First, the invention allows consumers to become aware of problems with their HVAC systems before the system fails to provide adequate heating, ventilation and/or air conditioning. The invention also automates the process of finding a servicer of the HVAC system, thereby eliminating the need to use the internet, local telephone books or word of mouth in finding a service technician that possesses the skills to service every HVAC system. This cuts down or eliminates the amount of time the consumer is without a functioning HVAC system.

Further, the invention facilitates the process of finding an appropriate HVAC technician to service an HVAC system by automating the process of finding an HVAC technician with the appropriate skills, an HVAC technician that has the time in his schedule to service the consumer's system, and an HVAC technician that is located within the vicinity of the consumer. Lastly, the invention eliminates the requirement of two technician visits to determine what is wrong with the HVAC system, identify the replacement part needed, travelling to pick up the replacement part and replacing the part in the HVAC system. By reporting to the technician exactly which replacement part is needed before he visits the HVAC system, the technician may pick up the replacement part before travelling to the HVAC system and therefore potentially repair the HVAC system in one trip. This process shortens the service experience and shortens the time the consumer is without a functioning HVAC system.

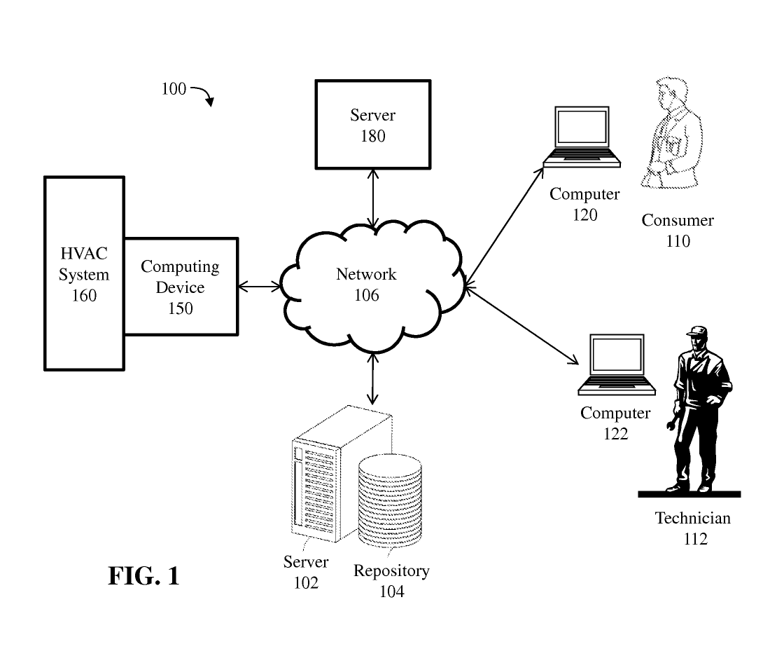

FIG. 1 is a diagram of an operating environment or system 100 that supports a process for monitoring heating, ventilation and air conditioning (HVAC) systems and facilitating service calls over a communications network 106, according to an example embodiment. The environment 100 may comprises a computing device 150, computers 120, 122 and servers 102, 180, all of which may communicate with server 102 via a communications network 106. Computing device 150 and computers 120, 122 may comprise any computing devices, such as integrated circuits, printed circuit boards, processors, ASICs, PCBs, cellular telephones, smart phones, tablet computers, desktop computers, laptops, and game consoles, for example. Computing device 150 and computers 120, 122 may be connected either wirelessly or in a wired or fiber optic form to the communications network 106. Communications network 106 may one or more packet switched networks, such as the Internet, or any local area networks, wide area networks, enterprise private networks, cellular networks, phone networks, mobile communications networks, or any combination of the above. In one embodiment, computing device 150 is a programmable logic controller or PLC.

Server 102 includes a software engine that delivers applications, data, program code and other information to networked devices 120, 122. The software engine of server 102 may perform other processes such as transferring multimedia data in a stream of packets that are interpreted and rendered by a software application as the packets arrive. FIG. 1 further shows that server 102 includes a database or repository 104, which may be a relational database comprising a Structured Query Language (SQL) database stored in a SQL server or a database that adheres to the noSQL paradigm. Mobile computing devices 120, 122 may also each include databases. The database 104 may serve sensor data, as well as related information, used by server 102 and mobile computing devices 120, 122 during the course of operation of the invention.

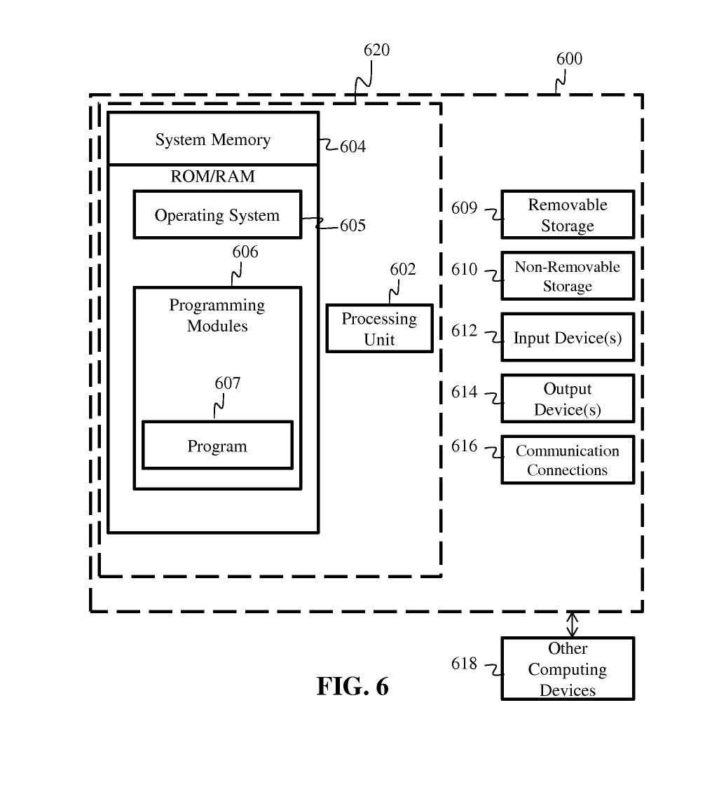

Computing device 150, computers 120, 122 and servers 102, 180 may each include program logic comprising computer source code, scripting language code or interpreted language code that perform various functions of the present invention. In one embodiment, the aforementioned program logic may comprise program module 607 in FIG. 6. It should be noted that although FIG. 1 shows only one computing device 150, two client computing devices 120,122 and one server 102, the system of the present invention supports any number of computing devices, servers and client computing devices connected via network 106. Also note that although server 102 is shown as a single and independent entity, in one embodiment, server 102 and its functionality can be realized in a centralized fashion in one computer system or in a distributed fashion wherein different elements are spread across several interconnected computer systems.

Various types of data may be stored in the database 104 of server 102. For example, the database 104 may store one or more records for each computing device 150, i.e., a device record. A device record may include a device unique identifier, device owner contact information, a device message format, device sensor parameter data and a first device type. A device unique identifier may be an alphanumeric value that is unique to a particular computing device 150. Device owner contact information may include the contact information for the person or entity that owns or possesses the device, such as the contact information for the person that owns the home where the HVAC system 160 is located. Device owner contact information may include name, address, telephone number, email address, GPS coordinates, etc. Alternatively, instead of storing device owner contact information in a device record, the device record may store the device location, which may be a geographical address or GPS coordinates representing the location of the device.

A device message format defines the format of messages sent by the computing device. An example of a device message format includes a map that defines each bit of a message (or a data packet comprising a portion of a message) and what data is represented by each bit of the message or data packet.

Device sensor parameter data defines the sensor data that will be provided by the device and the parameters for each sensor datum. In one example, device sensor parameter data may specify that a device message will specify the number of blinks exhibited by each of two LEDs of the HVAC system 160. In another example, device sensor parameter data may further specify that a device message will specify a temperature reading, a range a values for a temperature reading, a humidity reading, a range a values for a humidity reading, a barometric pressure reading, and a range a values for a barometric pressure reading. A first device type may be an alphanumeric value that indicates a model number, version number, make description, etc. of the HVAC system 160. A device record may also include demographic data for a device owner and a distance or geographic range that defines a geographic range or area that shall be searched when seeking a technician to service the device.

In one embodiment, a device record may also include a map or table that defines what certain fault codes, malfunction codes or light blink sequences mean. The map or table may describe or define the reason for a malfunction or fault, including the malfunctioning part or component. For example, the chart may specify that when the top or green LED 250 blinks two at a time and the bottom or red LED 252 blinks three at a time, this indicates that the exterior compressor is damaged, which requires the exterior compressor to be replaced. The map or table may further include severity indicator that indicates the severity or urgency of a problem exhibited by the system 160. A low severity indicator may indicate that a notice should be sent to the technician 122 either once or once every period of time, while a more severe emergency indicator may indicate that a notice or alert should be sent to the technician 122 periodically over a short period of time. The severity indicator may be a textual value or it may be a numerical value in a continuous range from 1 to 100. In another embodiment, the map or table described above is not located in the device record but rather is located in a separate device profile record, wherein the device record includes a pointer to the separate device profile record (and/or the device profile record includes a pointer to the device record).

In another example, the database 104 may store one or more records for each technician 112, i.e., a technician record. A technician record may include technician contact information (such as name, address, telephone number, email address, GPS coordinates, etc.) and a list of device types (such that described for the first device type above) that represent devices serviced by the technician. I.e., the list of device types represent the service skills possessed by a particular technician regarding his ability to service certain types of HVAC systems. A technician record may also include a unique identifier for a technician, demographic data for a technician and a distance or geographic range that defines a geographic range or area that is serviced by the technician. In yet another example, the database 104 may store one or more device profile records wherein each such record may include a map or table that defines what certain fault codes, malfunction codes or light blink sequences mean.

In one embodiment, a device record may include any of the data found in a technician record, or a device record may include a link to one or more technician records, such that it is predefined which technician or technicians are slated or assigned to service the HVAC system of the device record. In another embodiment, a technician record may include any of the data found in a device record, or a technician record may include a link to one or more device records, such that it is predefined which technician or technicians are slated or assigned to service the HVAC system(s) of the device record(s).

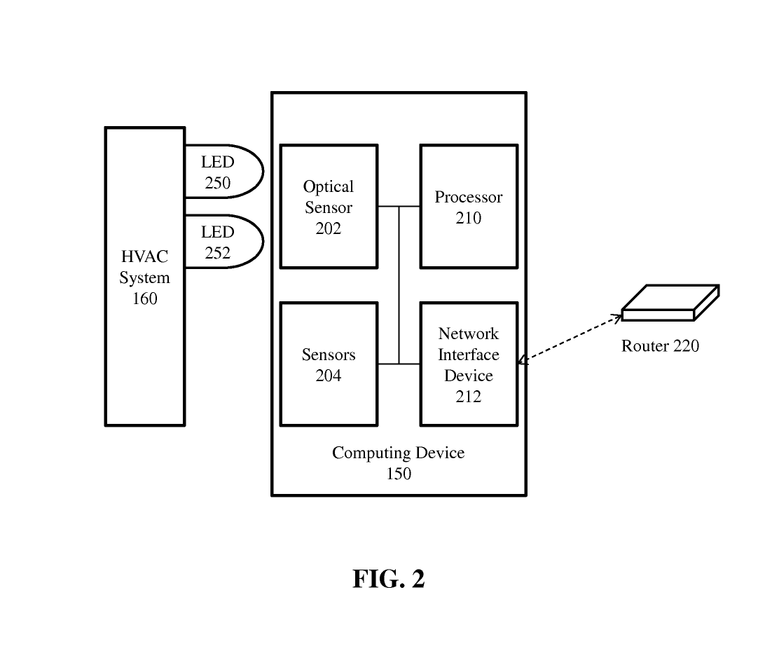

FIG. 2 is a block diagram showing the main components of a computing device 150 for monitoring HVAC systems using the communications network 106, according to an example embodiment. FIG. 2 shows that computing device 150 includes a processor 210 and a network interface device 212, as described more fully in FIG. 6 below. A network interface device 212 (also known as a network interface card, network adapter, LAN adapter and by similar terms) is a computer hardware component that connects a computer to a computer network, such as network 106. The network interface device 212 implements the electronic circuitry required to communicate using a communications protocol such as Ethernet, Wi-Fi, ZigBee or Token Ring. In one embodiment, the network interface device 212 may connect (in either a wired or wireless manner) to a router 220, which may be located at or near the home, office or building that houses the HVAC system 160.

FIG. 2 also shows that computing device 150 may include one or more optical sensors 202 that sense light or other electromagnetic emissions from two LEDs 250, 252 of the HVAC system 160. The one or more optical sensors 202 may sense and report the number of blinks exhibited by each of the two LEDs, as well as the color exhibited by each LED in each blink. Optical sensors 202 may include a photo sensor, photo detector, photo diode light sensor, camera, charged coupled device, photovoltaic cell, phototube, active pixel sensor, CMOS, DSLR, or the like. FIG. 2 also shows that computing device 150 may include one or more environmental sensors 204, which may comprise temperature sensors, humidity sensors, carbon monoxide sensors, water sensors, barometric pressure sensors, moisture sensors, acceleration sensors, or the like. The sensors 202, 204 may report sensor data to the processor 210, which then transmits the sensor data to the server 102 via network interface device 150.

In one embodiment, computing device 150 has a direct data communication connection with the processor or communications bus of the HVAC system 160, such as a serial data port connection, which may be a physical wire interface through which data transfers. Examples of a serial data port connection include FireWire and USB. In this embodiment, the computing device 150 receives message from the processor or communications bus of the HVAC system 160, wherein the message may include troubleshooting messages, sensor readings, fault codes, malfunction codes and the like.

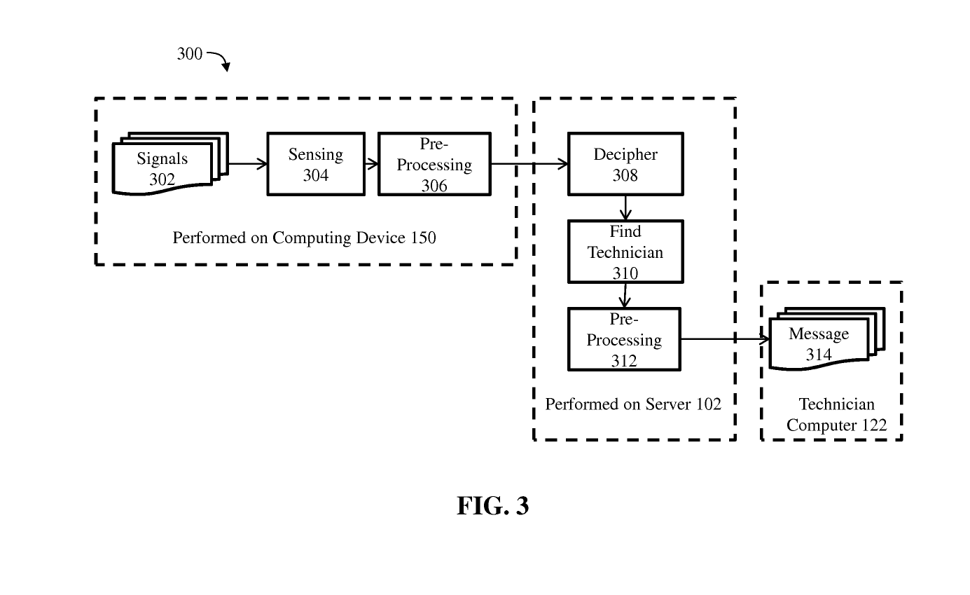

FIG. 3 is a block diagram showing the overall functions or processes 300 performed by the main components of the system 100 for monitoring HVAC systems and facilitating service calls over the communications network 106, according to an example embodiment. FIG. 3 shows how computing device 150 collects sensor data from an HVAC system 160, sends the sensor data to server 102, which processes the sensor data and generates a service message that may be displayed for a technician 122 to view on his computer 122. The process starts with the emanation of signals 302 by the HVAC system 160. The signals 302 may include the blinking of lights, sensor data, troubleshooting messages, fault codes, or the like (as described above). Next, a sensing process 304, which may be implemented by sensors 202, 204, reads the signals 302. Then, based on the signals 302 that were sensed, device 150 performs pre-processing 306 on a message that is sent to the server 102. In one embodiment, pre-processing 306 may include encoding data into a message format ready for transmission to the server 102. The data encoded into the message may include the sensor data, as well as other data.

Next, the message is received by the server 102, which deciphers the message in step 308. This step may include reading the sensor data and any other data included in the message. Next, in step 310, the server 102 finds the correct technician 112 based on the data included in the message. Consequently, the server 102 reads the contact information of the technician it found in step 310, and performs pre-processing 312 on a message 314 that is sent to the computer 122 of the technician 112. Pre-processing 312 may include encoding data into a message format ready for transmission to the computer 122 of the technician 112. The data encoded into the message may include sensor data, as well as other data. The final result of process 300 is human readable data displayed on a screen or other computer display of computer 122 of the technician 112. Note that the dotted lines and related text of FIG. 3 indicate which devices of environment 100, in one embodiment, perform the processes 300.

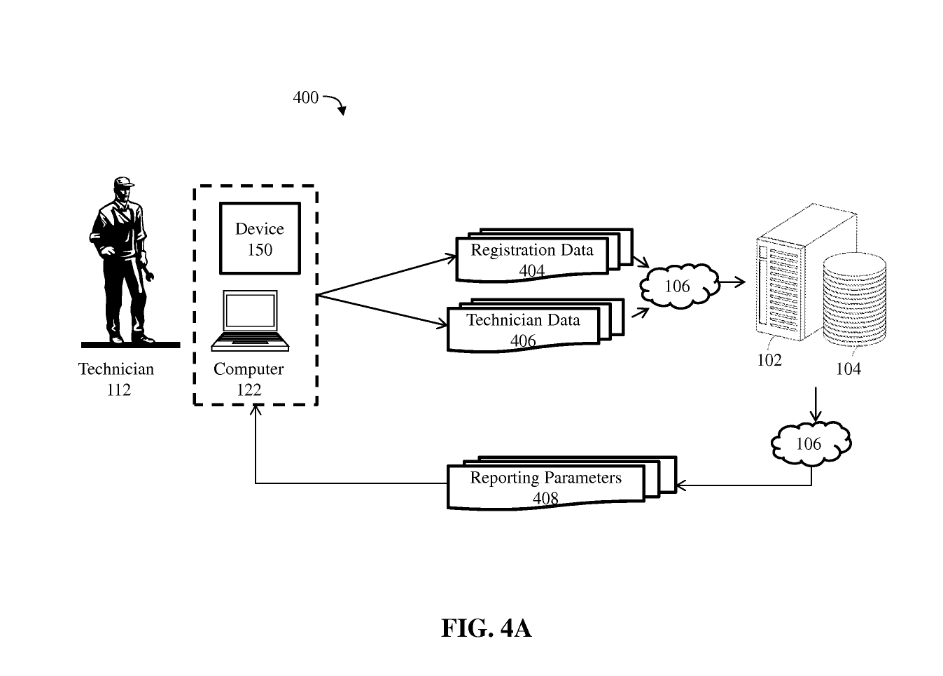

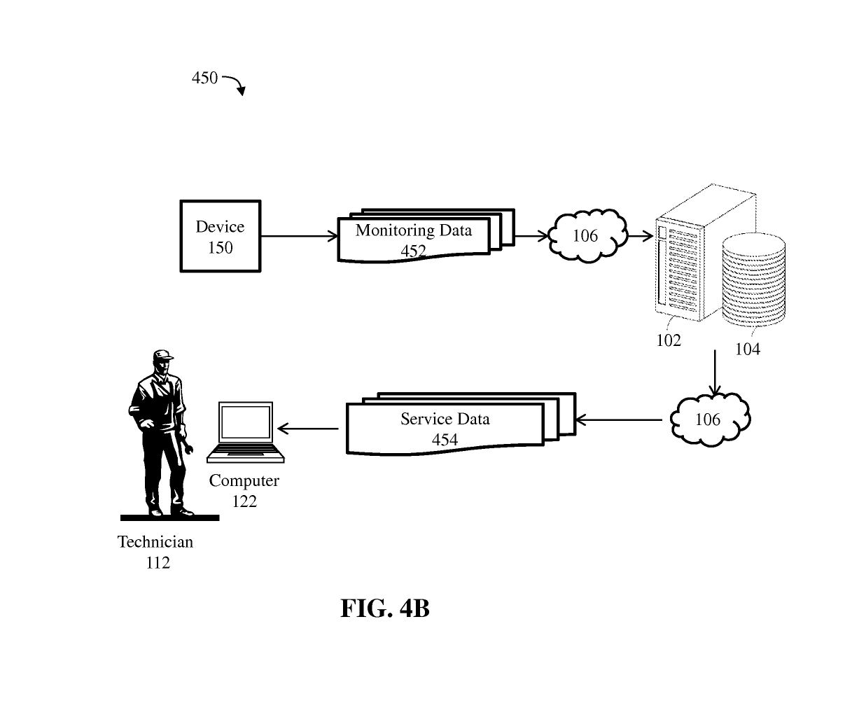

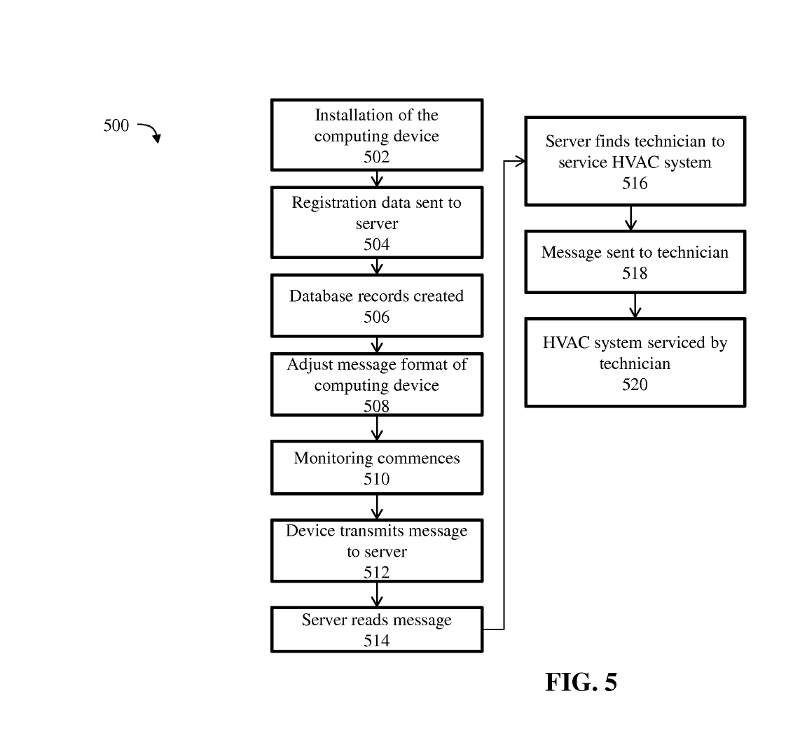

FIG. 5 is a flow chart showing the control flow of the process 500 for monitoring HVAC systems and facilitating service calls over the communications network, according to an example embodiment. Process 500 describes the general steps that occur when a computing device 150 is installed and registered, and subsequently begins operation monitoring and initiating service calls for HVAC system 160. The process 500 is described with reference to FIGS. 4A and 4B, wherein FIG. 4A shows the general data flow of the registration process 400 and wherein FIG. 4B shows the general data flow of the monitoring and service call process 450.

The process 500 begins with the installation 502 of the computing device 150, which may be a programmable logic controller, in relation to the HVAC system 160. As described above with respect to FIG. 2, the device 150 may be attached to the HVAC system 160 such that the device 150 may read LED data from the HVAC system 160 and take sensor readings using sensors 204. In another embodiment, the device 150 may be attached to the HVAC system 160 via a direct, wired data port connection such that the device 150 may read data from the HVAC system 160, as well as take sensor readings using sensors 204.

In step 504, the device 150 performs a registration process. In one embodiment, the registration process is performed by the computer 122 in conjunction with device 150. In this embodiment, the computer 122 connects to the device 150 either in a wired format, via a wired data port connection, or in a wireless format, using a wireless networking standard, such as ZigBee, WiFi or Bluetooth. In another embodiment, the registration process is performed by the computer 120 of consumer 110 in conjunction with device 150. In yet another embodiment, the registration process is performed solely by the device 150, wherein on-device settings such as a WiFi password, can be input into the device 150 using a small screen or other I/O interface in the device 150.

In step 504, the device 150 and/or computer 120/122 may send registration data 404 to the server 102. The registration data 404 may include any of the data included in a device record, as defined above, such as a device unique identifier, device owner contact information, a device message format, device sensor parameter data and a first device type. In one embodiment, certain ones of the registration data 404 may be predefined in the device 150 and therefore are not editable before transmission as registration data 404, such as device message format, device sensor parameter data and a first device type. In another embodiment, certain ones of the registration data 404 may be entered or defined by the consumer 110 or technician 112 in the computer 120 or 122 before transmission as registration data 404, such as device owner contact information.

In one optional embodiment, in step 504, the device 150 and/or computer 120/122 may send technician data 406 to the server 102. The technician data 406 may include any of the data that may be included in a technician record, as defined above. The technician data 406 corresponds to the technician 112 that has installed the computing device 150 in relation to the HVAC system 160.

In step 506, the server 102 may receive registration data 404 and create corresponding records in the database 104. In the case of receiving registration data 404, the server 102 creates one or more corresponding device records for the device 150 in the database 104. The one or more device records will include the data included in the registration data 404. In the optional case of receiving technician data 406, the server 102 creates one or more corresponding technician records for the technician 112 in the database 104. The one or more technician records will include the data included in the technician data 406. In another embodiment, prior to process 500, one or more corresponding technician records for the technician 112 already exist in the database 104. In this embodiment, the technician data 406 may simply include a unique identifier for the technician 112, such that the device record(s) can be associated with the technician record(s).

Optionally, in step 506, the device record(s) are associated with the technician record(s). In one alternative, the device record(s) may include the data of the corresponding technician record(s). In another alternative, the device record(s) may include a link to the technician record(s), such that it is predefined which technician or technicians are slated or assigned to service the HVAC system of the device record. In another alternative, the technician record(s) may include any of the data found in the corresponding device record(s), or the technician record(s) may include a link to the device record(s).

In optional step 508, the server 102 sends a message 408 to the device 150 defining the data required by the server 102, i.e., the desired reporting parameters of the device 150. In response, the device 150 adjusts its message format parameters (as defined in the device record, described above) to reflect those defined in the message. I.e., the device 150 adjusts the monitoring data 452 it sends to reflect what the server 102 desires. Recall that the device 150 may include a multitude of sensors 202, 204 and therefore may possess a multitude of sensor data to report to server 102. But server 102 may not require all of the sensor data available, and therefore, in order to save bandwidth, processing and usage, the server 102 may specify the subset of data required by the server 102.

In step 510, the installation and registration procedures have concluded and the monitoring process begins. In step 512, the device 150 receives signals 302 from the device 150. The signals 302 may include the blinking of lights, sensor data, troubleshooting messages, fault codes, or the like (as described above). Also in step 512, the device 150 generates a message including monitoring data 452 and sends the message to the server 102. The monitoring data 452 may include any of the sensor data sensed by device 150, as well as additional data, such as a device unique identifier for the device 150.

In one optional step after step 512, the message generated by device 150 is sent to a message queue or buffer pool server. This function of the message queue or buffer pool server is to buffer incoming messages faster than other servers can process in a timely fashion. The queuing or buffering process allows for greater scalability by allowing the server 102 to catch up to or start more server instances to process larger amounts of messages in parallel.

In step 514, the server 102 receives the message, un-encodes or deciphers the message and reads the data in the message. The server 102 may read the device unique identifier in the message, and subsequently accesses a device record in the database 104 that matches the device unique identifier. Any of the data available in a device record may be accessed and read in this step. For example, in step 514, the server 102 reads from the device record the device owner contact information, device message format, device sensor parameter data and the first device type. Then, the server 102 reads the sensor data from the message according to the device message format and the device sensor parameter data.

In one embodiment, in step 514, the server 102 reads from the device record the table that defines what sensor data means. The map or table describes the reason for a malfunction or fault, including the malfunctioning part or component. For example, the chart may specify that the sensor data indicates that the exterior compressor is damaged, which requires the exterior compressor to be replaced. Also, in step 514, the server 102 compares the sensor data from the message to the chart to determine the reason for the malfunction or fault. In another embodiment, in step 514 the server 102 reads from the map or table the severity indicator that indicates the severity or urgency of a problem exhibited by the system 160, as indicated in the message received from the device 150. A low severity indicator in the message may indicate that a notice should be sent to the technician 122 either once or once every period of time, while a more severe emergency indicator in the message may indicate that a notice or alert should be sent to the technician 122 periodically over a short period of time.

In step 516, the server 102 finds a technician to service the HVAC system 160 connected to device 150. The server 102 accomplishes this by accessing in the database 104 a technician record having an address in the technician contact information within a predefined area of an address of the device contact information, and having a device type that matches the first device type. That is, in step 516 the server 102 looks for a technician record with an address within a predefined range of the address of the HVAC system 160 (i.e., the device contact information) and with a device type that matches the type of device 150 (i.e., the first device type). In one embodiment, this search is performed by a separate search server 180.

In one alternative to step 516, the server 102 simply looks for technician contact information (or a link to a technician record) within the device record itself. This alternative is used in cases where it is predefined which technician or technicians are slated or assigned to service the HVAC system 160 of the device record. In another alternative to step 516, in order to determine whether a technician 112 qualifies as a match, the server 102 may access a scheduling or calendaring program of the technician 112 (wherein the scheduling or calendaring program includes the current work schedule or itinerary of the technician 112) to determine whether the technician 112 has any availability to service system 160. If the technician has no availability, then the technician 112 is not a match. If the technician has availability, then the technician 112 can be a match, provided that the address and skills of the technician 112 also match, as described above.

In step 518, the server 102 generates a message and sends the message to the computer 122 of technician 112. In this step, the message may include any of the sensor data, any of the data in the device record (such as first device type and device contact information), as well as the reason for the malfunction or fault, as determined by the server in step 514. In step 518, the message may be sent to the email address, telephone number or other address of the technician using the technician contact information in the technician record found in step 516. In step 520, the technician 112 services the HVAC system 160 connected to device 150. Prior to serving the system 160, the technician may contact the owner of the home or building in which device 150 is housed, by using the contact information associated with the device 150. Alternatively, the server 102 may contact, in an automated fashion, the owner of the home housing the device 150, such as by using email, text or an automated phone call. In this manner, the technician or server 102 may arrange for the technician to visit the HVAC system 160.

In an optional step before step 520, the server 102 may access a scheduling or calendaring program of the technician 112 to automatically place the servicing of system 160 directly into the scheduling or calendaring program of the technician 112, so as to ensure that the system 160 will be serviced.

In one embodiment, the communications protocol used to send messages or data to and from computers 150, 180, 102, 120 and 122 include any of the communications protocols known in the art, such as HTTP, TCP, UDP, ICMP, FTP, MQTT and IMAP. In another embodiment, the communications protocol used to send messages or data to and from computers 150, 180, 102, 120 and 122 include any of the communications protocols that would fall under the Application Layer (7) of the OSI model.

FIG. 6 is a block diagram of a system including an example computing device 600 and other computing devices. Consistent with the embodiments described herein, the aforementioned actions performed by computing device 150, server 102, and computers 120, 122 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 600 may comprise an operating environment for systems 100, 200 and processes 300, 400, 450, 500, as described above. Processes 300, 400, 450, 500 may operate in other environments and are not limited to computing device 600.

With reference to FIG. 6, a system consistent with an embodiment of the invention may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination or memory. System memory 604 may include operating system 605, and one or more programming modules 606. Operating system 605, for example, may be suitable for controlling computing device 600's operation. In one embodiment, programming modules 606 may include, for example, a program module 607 for executing the actions of server 102 and computing device 150, for example. Furthermore, embodiments of the invention may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. The aforementioned devices are only examples, and other devices may be added or substituted.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g. program module 607) may perform processes including, for example, one or more of the stages of the process 500 as described above. The aforementioned processes are examples, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A distributed system for providing monitoring of heating, ventilation and air conditioning (HVAC) systems, comprising:
1) a database connected to a communications network, the database comprising: a) a plurality of device records, wherein each device record includes a device unique identifier, device owner contact information, a device message format, device sensor parameter data and a first device type, and b) a plurality of technician records, wherein each technician record includes technician contact information and a list of device types representing devices serviced by the technician;
2) a computing device connected to the HVAC system, the computing device comprising:
a network interface device for connecting the computing device to the communications network;
an optical sensor located adjacent to one or more light emitting devices of the HVAC system, the optical sensor for sensing light emanating from the light emitting devices and generating corresponding sensor data;
a processor for reading the sensor data from the optical sensor and transmitting a message over the communications network via the network interface device, wherein the message is formatted according to the message format of the computing device and wherein the message includes the sensor data and a device unique identifier; and
3) a server comprising:
a network interface device for connecting the server to the communications network; and
a processor configured for: a) receiving the message from the computing device via the network interface device, b) reading the device unique identifier in the message, c) searching for and identifying a device record in the database that matches the device unique identifier, d) reading from the device record the device owner contact information, device message format, device sensor parameter data and the first device type, e) reading the sensor data from the message according to the device message format and the device sensor parameter data, f) searching for and identifying a technician record in the database having an address in the technician contact information within a predefined area of an address of the device contact information, and having a device type that matches the first device type, and g) sending, via the network interface device, a message to the technician using the technician contact information, wherein the message includes the sensor data, the first device type and the device owner contact information.

2. The distributed system of claim 1, wherein the optical sensor further detects a color of light emanating from the light emitting devices and generates corresponding sensor data.

3. The distributed system of claim 2, wherein the computing device further includes at least one environmental sensor located adjacent to the HVAC system, wherein the at least one environmental sensor for sensing environmental data associated with the HVAC system.

4. The distributed system of claim 3, wherein an environmental sensor may comprise any one of a temperature sensor, a humidity sensor, a carbon monoxide sensor, a water sensor, a barometric pressure sensor, a moisture sensor, and an acceleration sensor.

5. The distributed system of claim 1, wherein the database further includes a table associated with each device record, wherein the table maps sensor data to a description of a problem with the HVAC system.

6. The distributed system of claim 1, wherein the table maps sensor data to a description of a problem with the HVAC system and a level of severity of the problem.

7. The distributed system of claim 6, wherein the processor is further configured for reading from the device record the table, identifying in the table a description of a problem with the HVAC system and a level of severity of the problem that corresponds to the sensor data read from the message, and sending, via the network interface device, a message to the technician using the technician contact information, wherein the message includes the sensor data, the first device type, the device owner contact information, the description of the problem with the HVAC system and the level of severity of the problem.

8. A distributed system for providing monitoring of heating, ventilation and air conditioning (HVAC) systems, comprising:
1) a database connected to a communications network, the database comprising: a) a plurality of device records, wherein each device record includes a device unique identifier, a device location, and a first device type, and b) a plurality of technician records, wherein each technician record includes technician contact information and a list of device types representing devices serviced by the technician;
2) a computing device connected to the HVAC system, the computing device comprising:
a network interface device for connecting the computing device to the communications network;
an optical sensor located adjacent to one or more light emitting devices of the HVAC system, the optical sensor for sensing light emanating from the light emitting devices and generating corresponding sensor data;
a processor for reading the sensor data from the optical sensor and transmitting a message over the communications network via the network interface device, wherein the message is formatted according to the message format of the computing device and wherein the message includes the sensor data and a device unique identifier; and
3) a server comprising:
a network interface device for connecting the server to the communications network; and
a processor configured for: a) receiving the message from the computing device via the network interface device, b) reading the device unique identifier in the message, c) searching for and identifying a device record in the database that matches the device unique identifier, d) reading from the device record the device location and the first device type, e) reading the sensor data from the message, f) searching for and identifying a technician record in the database having an address in the technician contact information within a predefined area of the device address, and having a device type that matches the first device type, and g) sending, via the network interface device, a message to the technician using the technician contact information, wherein the message includes the sensor data, the first device type and the device location.

9. The distributed system of claim 8, wherein the optical sensor further detects a color of light emanating from the light emitting devices and generates corresponding sensor data.

10. The distributed system of claim 9, wherein the computing device further includes at least one environmental sensor located adjacent to the HVAC system, wherein the at least one environmental sensor for sensing environmental data associated with the HVAC system.

11. The distributed system of claim 10, wherein an environmental sensor may comprise any one of a temperature sensor, a humidity sensor, a carbon monoxide sensor, a water sensor, a barometric pressure sensor, a moisture sensor, and an acceleration sensor.

12. The distributed system of claim 8, wherein the database further includes a table associated with each device record, wherein the table maps sensor data to a description of a problem with the HVAC system.

13. The distributed system of claim 8, wherein the table maps sensor data to a description of a problem with the HVAC system and a level of severity of the problem.

14. The distributed system of claim 13, wherein the processor is further configured for reading from the device record the table, identifying in the table a description of a problem with the HVAC system and a level of severity of the problem that corresponds to the sensor data read from the message, and sending, via the network interface device, a message to the technician using the technician contact information, wherein the message includes the sensor data, the first device type, the device location, the description of the problem with the HVAC system and the level of severity of the problem.

15. A distributed system for providing monitoring of heating, ventilation and air conditioning (HVAC) systems, comprising:
1) a database connected to a communications network, the database comprising: a) a plurality of device records, wherein each device record includes a device unique identifier, a device location, a first device type and a table associated with each device record, wherein the table maps sensor data to a description of a problem with the HVAC system, and b) a plurality of technician records, wherein each technician record includes technician contact information and a list of device types representing devices serviced by the technician;
2) a computing device connected to the HVAC system, the computing device comprising:
a network interface device for connecting the computing device to the communications network;
an environmental sensor located adjacent to the HVAC system, wherein the at least one environmental sensor for sensing environmental data associated with the HVAC system and generating corresponding sensor data;
a processor for reading the sensor data from the optical sensor and transmitting a message over the communications network via the network interface device, wherein the message is formatted according to the message format of the computing device and wherein the message includes the sensor data and a device unique identifier; and
3) a server comprising:
a network interface device for connecting the server to the communications network; and
a processor configured for: a) receiving the message from the computing device via the network interface device, b) reading the device unique identifier in the message, c) searching for and identifying a device record in the database that matches the device unique identifier, d) reading from the device record the device location, the first device type and the table, e) reading the sensor data from the message, f) identifying in the table a description of a problem with the HVAC system that corresponds to the sensor data read, g) searching for and identifying a technician record in the database having an address in the technician contact information within a predefined area of the device address, and having a device type that matches the first device type, and h) sending, via the network interface device, a message to the technician using the technician contact information, wherein the message includes the sensor data, the first device type, the description of the problem with the HVAC system and the device location.

16. The distributed system of claim 15, wherein the optical sensor further detects a color of light emanating from the light emitting devices and generates corresponding sensor data.

17. The distributed system of claim 18, wherein an environmental sensor may comprise any one of a temperature sensor, a humidity sensor, a carbon monoxide sensor, a water sensor, a barometric pressure sensor, a moisture sensor, and an acceleration sensor.

18. The distributed system of claim 17, wherein the table maps sensor data to a description of a problem with the HVAC system and a level of severity of the problem.
